(19) United States
(12) Patent Application Publication
(10) Pub. No.: US 2025/0146341 A1
(43) Pub. Date: May 8, 2025

(54) SEPARABLE MOUNTING HINGE DEVICE

(71) Applicant: David L. BIGGERSTAFF, San Angelo, TX (US)

(72) Inventor: David L. BIGGERSTAFF, San Angelo, TX (US)

(73) Assignee: BFM INTERESTS, LLC, Bulverde, TX (US)

(21) Appl. No.: 18/503,363

(22) Filed: Nov. 7, 2023

(51) Int. Cl. E05D 7/10; E05D 3/02; E05D 5/12

(52) U.S. Cl. CPC E05D 7/1066; E05D 3/02; E05D 5/125

(57) ABSTRACT

A separable mounting hinge device including two detachably engageable leaf hinge members wherein the first hinge member includes at least two knuckles affixed around a pin leaving at least one open knuckle seat therebetween. The second hinge member includes at least one open knuckle capable of operationally engaging around the pin and at least one leaf-knuckle protrusion. The second hinge member may also include a retention member. These hinge members' knuckle(s) and affixed pin open knuckle seat(s) operationally interlock thereby allowing for typical hinge movements, while detachment of said members simply requires the application of force within specifically designated angular ranges to overcome the protrusion, and potentially included retention member. As designed, the separable mounting hinge device minimizes the likelihood of any incidental or accidental detachment and obviates the need to unfasten at least one hinge from a door, panel, or frame only to refasten it later.

### BACKGROUND OF THE INVENTION

An expansive selection of hinges currently exist within the prior art, ranging from hinges for windows, cabinets, lids, airplane doors, vehicular components, refrigerators, to those for a plethora of other objects, specifically including hinges that are designed to be capable of pin removal, deterring hanging of items, preventing pinched fingers, lift-off separation, snap-in and snap-out, multi-directional adjustment, as well as those featuring hidden components therein.

Various hinges in the art are designed, built, and manufactured for very specific purposes relating to removal and separation, such as U.S. Pat. No. 1,578,408, issued to J. N. Diday, which relates particularly to caskets having lids that may be removably lifted off once swung into an abnormal position beyond a right angle, and U.S. Pat. No. 3,060,492, issued to W. Dellith, which relates particularly to airplane doors that should be completely removed to allow for easier removal of engines and other internal parts. More recently, these take-apart hinge designs and apparatuses have been joined by U.S. Pat. No. 9,416,574, issued to Mitchell et al., which relates particularly to freezer and refrigerator doors and discloses an anti-sag lift-off hinge apparatus to combat hinge wear, structural shifting due to temperature, poor design and abuse from constant use, while still guaranteeing proper locking and sealing to ensure proper usage thereby delaying the need for extensive and costly repair work, and U.S. Pat. No. 10,820,641, issued to Pandolfino, which relates to interchangeable take-apart hinges for neckwear modules having rotatably interlocking means of connection via a key and groove/keyway path.

Several other hinge prior art documents, such as U.S. Pat. No. 5,799,370, issued to Davidian et al., U.S. Pat. No. 6,516,494, issued to Nakamoto et al., U.S. Pat. No. 8,276,241, issued to Wu et al., U.S. Pat. No. 8,516,658, issued to Bultschnieder, and U.S. Pat. No. 10,459,165, issued to Tsai, each focuses their particular attention on allowing for adjustments in at least one axis of movement to be made after the installation of a hinge mechanism on both a door and its frame. These patent designs espouse different means of axial adjustment of a hinge mechanism during or after installation thereby obviating the need for an individual installer, or contractor, to remove, remeasure, and reattach all of the hinge mechanism's components while also entirely avoiding the issue of drilling new holes into a frame (or the door itself) so close to the first set that they bleed into, or connect with, one another thereby causing the entire door to wobble or sit off-kilter unless it, and/or the frame, is outright replaced.

Several other hinge prior art documents are specifically directed to snap-in and snap-out hinges, such as U.S. Pat. No. 5,806,144, issued to Fries, which has a spring-loaded peg that is slidably supported and forms a steplessly adjustable threaded engagement with an axially immovable but rotatable adjusting screw in the receiving part. U.S. Pat. No. 6,715,181, also issued to Fries, covers an adjusting screw mechanism having step flanges capable of bearing on either side of one hinge leaf to enable lateral adjustment of the hinge device about its pivot point as well as enabling height adjustment. Additionally, U.S. Pat. No. 11,692,360, issued to Fries et al., covers a dual hinge method wherein a permanent central hinge element is capable of fastening into, and out of, two separate components situated on the panel/door and on the frame jamb.

Additionally, there are hinge-related patents that specifically relate to switchgear cabinet hinges and mounts that are designed to sit flush into the overall frame (U.S. Pat. No. 8,056,993 issued to Stock et al.), plastic window and door-panel hinges affixed to jamb elements (U.S. Pat. No. 8,413,299 issued to Bartels), structures used for the connection of electronic devices and stands potentially having lifting members (U.S. Pat. No. 9,366,064 issued to Chen et al.), kits for realigning and replacing door hinges connected to a jamb and having differently sized gaps (U.S. Pat. No. 10,760,310 issued to Kessler), and hinges having rounded or sloped ends thereby assuring that nothing will catch or hang therefrom (U.S. Pat. No. 3,015,126 issued to A. W. Ahlgren). While several other prior art documents and publications relate to hinges for furniture, reinforced doors, tool boxes, and a multitude of other things.

As has been pointed out within many of the prior art documents, there are a multitude of problems with certain styles and designs of hinges, namely the unbalanced load and weight distribution between the lower hinges which tend to be weight-bearing and supporting the upper hinges which tend to be hanging. An additional aforementioned problem is the issues related to removal, replacement, and reattachment of hinges to both the frame jamb as well as the door or panel itself, specifically the complications resulting from drilling multiple holes near one another, reinserting a screw that has been removed and potentially widening a hole, with any looseness of the hinge assembly's installation causing a wobbly, creaky, non-fitting, or off-kilter door or panel. This issue is made worse as removal of a door, or panel, may be absolutely necessary for moving, remodeling, painting, or several other purposes and can't otherwise be avoided. Additionally, when a door or panel must be removed from its frame, the process itself usually requires at least two able-bodied persons to accomplish the task without causing undue damage to the frame, wall, floor, door/panel, or surrounding area. Hinges used in residential and commercial properties usually come in sets of three and require at least three or four screws in each leaf, such that when one person starts unscrewing them the entirety of the weight and force is transferred to the remaining attached screws, which pull at the frame (or door/panel) and may result in tearing or breaking unless the second person maintains a steady counterforce by holding the door or panel up in mid-air. Even still, it is a time-consuming process that typically results in some amount of damage being done to at least one component involved, and tends to require even more effort by these persons to reattach the door or panel once the moving, remodeling, or painting has been completed.

Therefore, what is needed in the art is a hinge device that allows for quick and easy detachment by a single person at a relatively controllable and normal angle without any of the aforementioned hassle related to unscrewing either leaf from the door, panel, or frame or related to the removal of the central pin in order to separate the leaf members. Unlike the prior art, which tend to require abnormal angles or significant manuvering in order to separate a hinge's leaf members, what is needed in the art is a separable mounting hinge device that operates within a specific range of angles between zero and ninety degrees, due to the fact that the vast majority of installed doors in residential and commercial properties will impact a wall if opened beyond ninety degrees. This device should allow a single user, who has enough strength to bear the weight of the door or panel, to simply unclip the hinge leaves thereby pulling them apart once the door has been swung to sit within the specified angular range. Additionally, there should be some element of this hinge device that will prevent any accidental dislodging or detachment of the door from its frame while it is sitting, or being operated, within this specific angular range.

### FIELD OF THE INVENTION

The present invention relates to a separable mounting hinge device, and more particularly, to a hinge that will be utilized by contractors, builders, constructors, and building owners alike who are looking to improve their offices, homes, or other properties through the installation of devices that allow doors to be removed and replaced more easily, rapidly, and conveniently for moving, repairing, painting, or a myriad of other purposes.

### SUMMARY OF THE INVENTION

The general purpose of the separable mounting hinge device, described subsequently in greater detail, is to provide a mounting hinge having leaf members that require no tools to separate and that have novel features resulting in a device which is not anticipated, rendered obvious, suggested, or even implied by prior art, either alone or in combination thereof.

According to one embodiment of the present invention, a separable mounting hinge device includes a first and second hinge member, wherein each is created from a single portion of metal, metallic alloys, or similarly durable hard polymer that has been cut, punched, turned, rolled, and otherwise manufactured as a whole. The last portion of the device in this embodiment is the pin, which is affixed into the first hinge member via the further rolling of the affixed knuckles of that hinge member around the pin. In contemplated embodiments, the affixed knuckles about the pin may make contact with the first leaf, thereby locking it into place, while additional embodiments may include heat to weld, or meld, the affixed knuckles around and to the pin thereby affixing it in place.

Furthermore, after the affixed pin has been locked into the space within the affixed knuckles of the first hinge member, there shall remain at least one open knuckle seat disposed along the affixed pin whereat the at least one open knuckle of the second hinge member may be removably attached to the first hinge member thereupon. This may be achieved by having the gap between the edge of the at least one open knuckle and the second leaf sized just wide enough to accommodate the open knuckle seat therethrough, one embodiment is contemplated as possessing open knuckles of the second hinge member measuring between ⅔ to ¾ of the length of the affixed knuckles of the first hinge member. The edge of these open knuckles may be flat, rounded, sharp-edged, cut and rolled, or some combination thereof. As such, the gap between the edge of the open knuckle of the second hinge member will allow for fitting around the open knuckle seat of the affixed pin of the first hinge member, but only when interaction occurs within a specific angular range. The leaf members, from which the affixed and open knuckles extend, may be rectangular, square, triangular, butterfly, or nearly any other shape and possess straight or rounded edges, so long as their structural integrity remains undiminished.

One embodiment contemplated herein envisions this specific angular range, or release position, as spanning 15 to 55 degrees as measured from the hinge's closed position, wherein the open knuckles of the second hinge member are operationally engaged to the affixed pin of the first hinge member along the open knuckle seats, and the leaf members are in direct physical contact with one another. This is compared with the hinge's open position, wherein the hinge members are operationally engaged to one another but the leaf members are not physically touching. Another embodiment contemplated herein envisions a smaller gap and window of operation such that the specific angular range spans 20 to 50 degrees as measured from the door's closed position with the smallest window possible as spanning 25 to 45 degrees as measured from the hinge's closed position.

The difference in these ranges correlates to the combination of structural factors relating to the aforementioned length of the open knuckles of the second hinge member, the cut and milling of the edge thereof, additionally present structural features, as well as possible variation of the pin member along the open knuckle seats thereof. As such, the smallest window possible may see portions of the pin flattened to a narrower dimensionality with the open knuckle(s) of the second hinge member having a complementary lengthening ending at a flat edge, wherein no rounded portion of the pin could pass through the open knuckles of second hinge member, but only within the specified angular range would the narrower affixed pin of the first hinge member be capable of releasing from the open knuckle of the second hinge member.

It should be noted that within the contemplated embodiments of the present invention discussed herein, even though a door/panel possessing these hinges may be opened and remain within an aforementioned release position, the addition of force shall be required for removal. It is this application of force in a direction perpendicularly planar to the door's/panel's leaf member, without the need for upward lift, that is required to overcome the retention forces of the leaf-knuckle protrusions, and possible retention members, thereby allowing for separation of the hinge members. Similarly, it is due to release positions' specified angular ranges and the included structural features of the present invention, such as the leaf-knuckle protrusion and possibly included retention member, that spontaneous disconnection, or detachment, is highly unlikely to occur.

Embodiment of this invention are also contemplated as including additional retention members maintaining the affixed pin within the open knuckles of the second hinge member, such that an individual will only be able to intentionally separate the second hinge member from the affixed pin's open knuckle seat(s), as opposed to accidental or incidental detachment occurring and potentially causing injury or damage. Contemplated example embodiments of such retention members shall include, but not be limited to, the inclusion of at least one leaf-knuckle protrusion (or detent) along the second hinge member, as well as the inclusion of a retention ring inset along at least one open knuckle of the second hinge member and capable of operational engagement with the knuckle seat of the affixed pin of the first hinge member. These structural elements, as well as variations thereof, may each operate independently or in tandem to retain the affixed pin of the first hinge member within the open knuckle of the second hinge member in a safe, secure, and reusable manner while preventing, or at the very least diminishing, the capability of the hinge members to separate without the application of a certain amount of force in a specific direction within a specific angular range.

The at least one leaf-knuckle protrusion, or detent, contemplated within this and other embodiments of the present invention may be semi-spherical, rounded polygonal, hard-edged polygonal, or some combination thereof and may be disposed at a location on the second hinge member along the inner wall of the open knuckle, where the open knuckle meets the leaf member, or at a position adjacent thereto on the leaf member of the second hinge member. Additionally contemplated retention rings include, but shall not be construed as being limited to, crescent rings, e-clips, grip rings, housing rings, poodle clips, C-shaped rings, prong locked rings, and industrial class rings.

Thus has been broadly outlined the more important features of the present separable mounting hinge device so that the detailed description thereof that follows may be better understood and in order that the present contribution to the art may be better appreciated.

Objects of the present separable mounting hinge device, along with various novel features that characterize the invention are particularly pointed out in the claims forming a part of this disclosure. For better understanding of the separable mounting hinge device, its operating advantages and specific objects attained by its uses, refer to the accompanying drawings and description.

### BRIEF DESCRIPTION OF THE DRAWINGS

### Figures

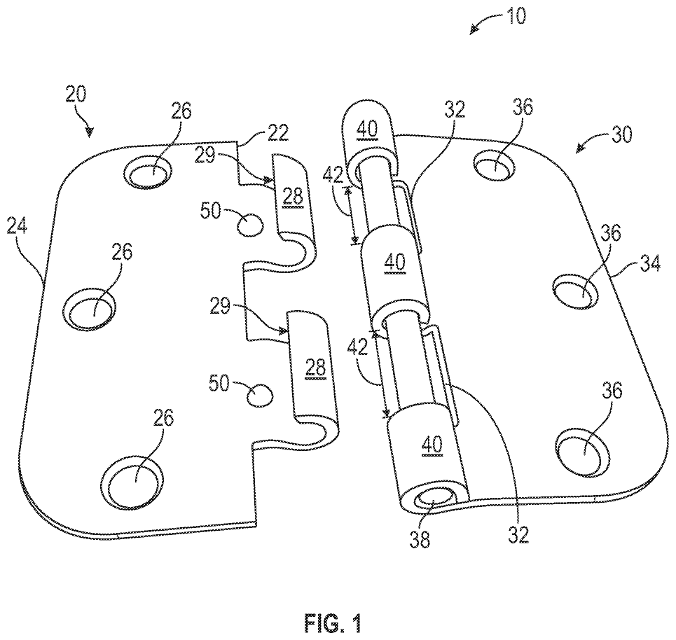

FIG. 1 is an isometric view of one separated embodiment of the separable mounting hinge device.

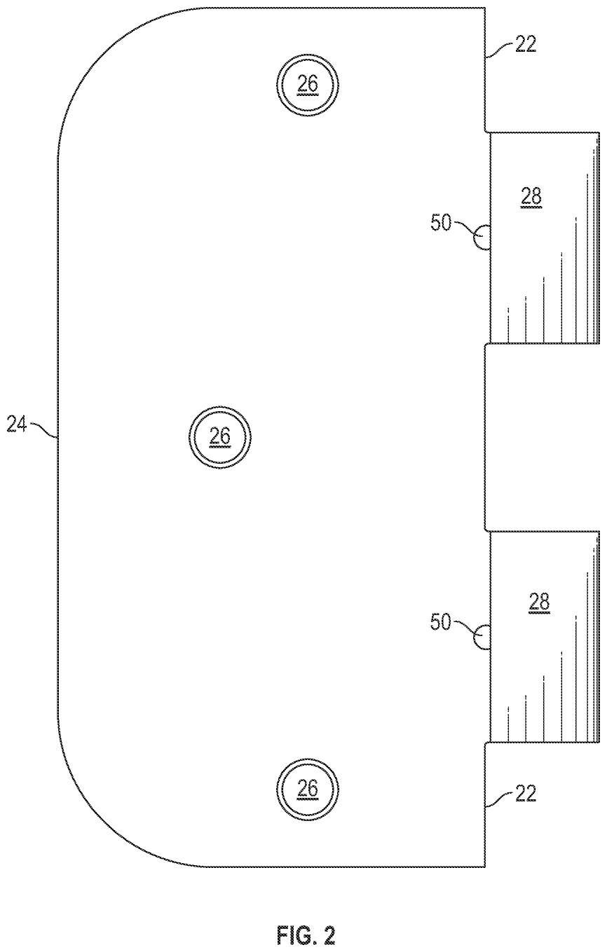

FIG. 2 is an aerial view of one embodiment of the attachable second leaf member of the separable mounting hinge device.

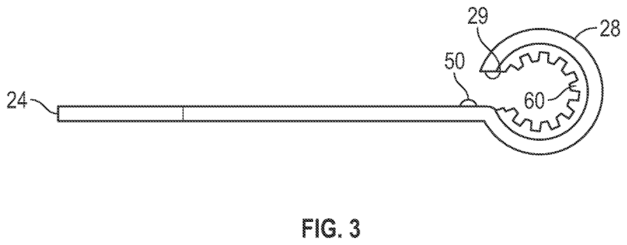

FIG. 3 is a side view of one embodiment of the attachable second leaf member of the separable mounting hinge device.

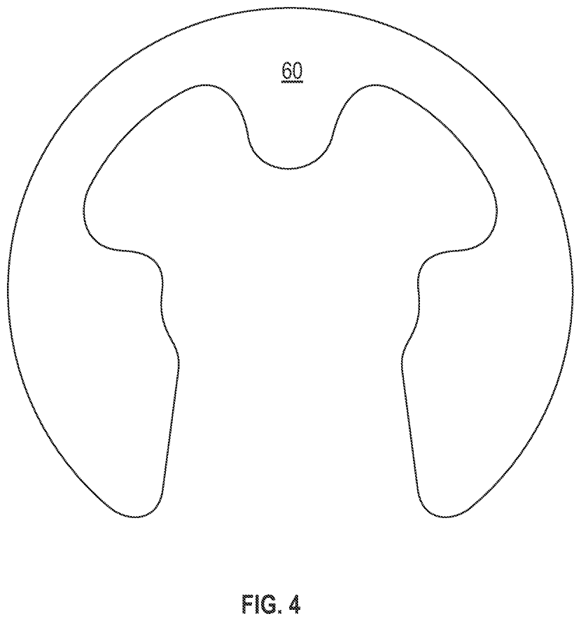

FIG. 4 is an aerial view of one embodiment of the retention member of the separable mounting hinge device.

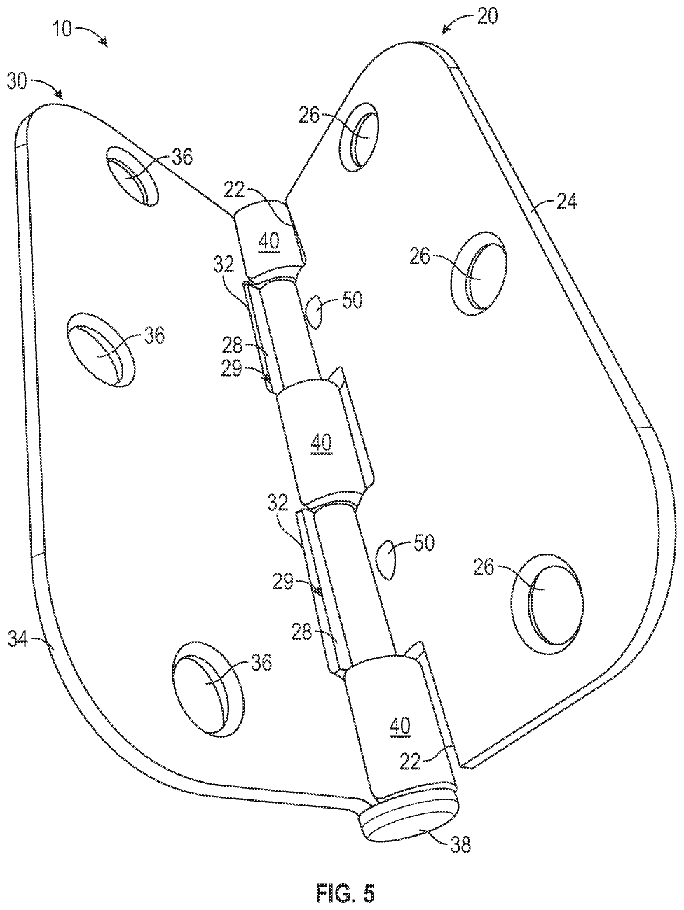

FIG. 5 is an isometric view of one interlocked embodiment of the separable mounting hinge device.

### DETAILED DESCRIPTION OF THE DRAWINGS

With reference now to the drawings, and in particular FIGS. 1 through 5 thereof, example embodiments of the separable mounting hinge device employing a number of the principles and concepts discussed above, and generally designated by the reference number 10, will be described.

Referring to FIG. 1, an exemplary embodiment of the present separable mounting hinge device 10 is illustrated in a separated position. Separable mounting hinge device 10 has two main parts, second leaf (or hinge) member 20 and first leaf (or hinge) member 30. Second leaf member 20, also denoted herein as attachable leaf member, is comprised in this embodiment of second leaf proximal edge 22, second leaf distal edge 24, at least one second leaf aperture 26 (three of which are depicted in this embodiment), at least one open knuckle 28 (two of which are depicted in this embodiment) each having an open knuckle edge 29, and at least one leaf-knuckle protrusion 50 located about the transition bridge of second leaf member 20 and each open knuckle 28 protruding therefrom. First leaf member 30, also denoted herein as affixed leaf member, is comprised in this embodiment of first leaf proximal edge 32, first leaf distal edge 34, at least one first leaf aperture 36 (three of which are depicted in this embodiment), and affixed pin 38 positioned within at least two affixed knuckles 40 (three of which are depicted in this embodiment) wherein at least one open knuckle seat 42 (two of which are depicted in this embodiment) is available along affixed pin 38 between each pair of consecutive affixed knuckles 40.

Referring next to FIG. 2, an embodiment of second leaf member 20 is depicted having proximal edge 22, distal edge 24, aperture(s) 26, open knuckle(s) 28, and leaf-knuckle protrusion(s) 50 about the transition bridge of the body of second leaf member 20 to each open knuckle(s) 28.

Referring next to FIG. 3, an embodiment of second leaf member 20 is depicted having proximal edge 22, distal edge 24, open knuckle 28 having open knuckle edge 29, leaf-knuckle protrusion 50, and retention member 60. Operating in like manner as the other embodiments depicted herein, affixed pin 38 of first leaf member 30 may be engaged within each open knuckle 28 of second leaf member 20, however, in the present depiction the inclusion of operationally coupled retention member 60 within open knuckle 28 further increases the capability of open knuckle 28 to retain affixed pin 38 therein while occupying open knuckle seat 42. Shown as being utilized in conjunction with leaf-knuckle protrusion 50, though capable of use without it, the amount of force required to separate first and second leaf member 30, 20 from one another is increased once affixed pin 38 operationally engages with retention member 60, thereby decreasing the likelihood of incidental or accidental separation.

Referring to FIG. 4, an additionally contemplated design of retention member 60 is depicted and contemplated as within the scope of separable mounting hinge device 10. While additional ring or clip retention members 60 are known within the art and are contemplated as capable of inclusion in the present invention, they are not illustrated.

Referring next to FIG. 5, separable mounting hinge device 10 like the embodiment of FIG. 1 is shown, but in an interlocked open position. Interlocking of second leaf member 20 and first leaf member 30 occurs through the positioning of affixed pin 38 along open knuckle seat(s) 42 within open knuckle(s) 28 wherein the portions of separable mounting hinge device 10 must be engaged within the specifically disclosed angular range while an amount of force is required to overcome all leaf-knuckle protrusion(s) 50 present.

Although leaf-knuckle protrusion 50 is shaped in this, and other, illustrated example embodiments as a circular fully rounded protrusion that resembles a bubble, it is further contemplated herein that this feature may also resemble a raised bump, nodule, or polygon having a round, ovular, square, diamond, or other polygonal form (or some combination thereof) wherein the portion facing open knuckle(s) 28 is smooth while the remaining other sides may be either smooth, hard-edged, or some design therebetween. Likewise, although circular second leaf aperture(s) 26 and first leaf aperture(s) 36 are depicted in this, and previous, figured embodiments it is further contemplated herein that these may be shaped in any polygonal or rounded form. It is additionally contemplated that no apertures need be present within either first or second leaf member 30, 20 such that the members may be glued, cemented, or otherwise permanently affixed to doors, panels, frames, or the like without need of fasteners.

Furthermore, though second and first leaf members 20, 30 are depicted as rectangular having two rounded corners, it is contemplated that these portions of separable mounting hinge device 10 may be shaped to resemble rectangular, triangular, square, butterfly, butt, trapezoidal, or other polygonal forms possessing angled, flat, and/or rounded edges and corners. Similarly, although each open knuckle 28 depicted in these figures possesses a circularly rounded curled body, it is further contemplated herein that this curled body may be ovoid, elliptical, or similarly rounded so long as affixed pin 38 is capable of housing therein, while each open knuckle edge 29 may possess a squared off, angle cut, or rounded edge. The inclusion of such contemplated open knuckle 28 body shapes and open knuckle edge 29 designs may be, at least in part, reliant on the variety of affixed pin 38 designs contemplated herein, wherein portions thereof (especially those of open knuckle seat 42) may be smooth, grooved, milled, or some combination thereof.

Thus, separable mounting hinge device 10 further contemplates that where affixed pin 38 may be milled, grooved, flattened, or otherwise made different (than it would typically be in the first embodiment described) along open knuckle seat 42, the shapes/designs of open knuckle 28, protrusion 50, and retention member 60 may all be altered to better complement such a differentiation. In such a contemplated embodiment, such as where narrowing occurs, the curled body of open knuckle 28 may be elongated and/or open knuckle edge 29 may be altered while retention member 60 may be changed to better fit the altered cross-section shape, such as rounded rectangular as opposed to the circular one illustrated within FIGS. 1 and 5.

Lastly, due to the potential inclusion of separable mounting hinge device 10 within numerous construction projects located both indoor and outdoor, and due to the continuous separation and reengaging use of the present invention, each first and second leaf member 30, 20 thereof may be manufactured from a single sheet of strong, durable, and corrosion resistant material. Additionally, it is further contemplated that each of the corrosion resistance, strength, and durability may be imparted or augmented through supplementary galvanization, vulcanization, or other coating processes. Materials contemplated as preferred for separable mounting hinge device 10 include, but should not be construed as limited to, metals such as aluminum, iron, and nickel, metallic alloys such as steel, brass, and bronze, as well as similarly characterized polymeric materials.

What is claimed is:

1. A separable mounting hinge device comprising:
a first hinge member comprising:
a first leaf having a proximal edge, a distal edge, and two shorter edges therebetween;
an affixed pin;
at least two affixed knuckles extending from the proximal edge and curled around the affixed pin; and
at least one open knuckle seat between the affixed knuckles about the affixed pin; and
a second hinge member comprising:
a second leaf having a proximal edge, a distal edge, and two shorter edges therebetween;
at least one open knuckle extending from the proximal edge having an edge and a curled body; and
at least one leaf-knuckle protrusion disposed about where the at least one knuckle extends from the proximal edge of the second leaf;
wherein the at least one open knuckle of the second hinge member is disposed to detachably engage with the at least one open knuckle seat of the first hinge member but only when insertion or removal occurs within a specified angular range;

2. The separable mounting hinge device of claim 1 wherein the curled body of the at least one knuckle of the second hinge member is formed to an arc complementary to the section of the affixed pin present along the at least one open knuckle seat.

3. The separable mounting hinge device of claim 1 wherein the at least one knuckle of the second hinge member possesses a squared off, angle cut, or rounded edge.

4. The separable mounting hinge device of claim 1 wherein the first hinge member further comprises at least one aperture extending through the first leaf.

5. The separable mounting hinge device of claim 1 wherein the second hinge member further comprises at least one aperture extending through the second leaf.

6. The separable mounting hinge device of claim 1 wherein the length of the curled body of the at least one knuckle of the second hinge member measures between ⅔ to ¾ of the length of one of the at least two knuckles curled around the affixed pin.

7. The separable mounting hinge device of claim 1 wherein the at least one leaf-knuckle protrusion of the second hinge member maintains the detachable engagement of the first and second hinge members until they are opened at a specified angular range and force is applied to traverse the protrusion and remove the second hinge member from the first hinge member.

8. The separable mounting hinge device of claim 7 wherein the at least one open knuckle of the second hinge member is only capable of operationally engaging with, or disengaging from, the at least one open knuckle seat of the first hinge member when inserted at a specified angular range of fifteen to fifty-five degrees.

9. The separable mounting hinge device of claim 1 wherein the shape of the curled body of the at least one knuckle of the second hinge member is circular, ovoid, elliptical, or similarly rounded.

10. The separable mounting hinge device of claim 7 wherein the at least one open knuckle of the second hinge member is only capable of operationally engaging with, or disengaging from, the at least one open knuckle seat of the first hinge member when inserted at a specified angular range of twenty-five to forty-five degrees.

11. The separable mounting hinge device of claim 1 wherein the at least one leaf-knuckle protrusion of the second hinge member is situated about the transition bridge between the second leaf and the at least one knuckle of the second hinge member.

12. The separable mounting hinge device of claim 1 wherein the at least one leaf-knuckle protrusion is a raised bump, nodule, bubble, or polygon that maintains the engagement of the first and second hinge members and prevents accidental or incidental dismounting of second hinge member from the first hinge member.

13. The separable mounting hinge device of claim 1 wherein the leaf-knuckle protrusion is shaped to resemble a round, ovoid, square, diamond, rectangular, triangular, or polygonal form, or some combination thereof having smooth portions and/or edged portions.

14. The separable mounting hinge device of claim 1 wherein the affixed pin is smooth, grooved, milled, flattened, or some combination thereof.

15. The separable mounting hinge device of claim 1 wherein the first and second leaves are shaped to resemble rectangles, triangles, squares, butterfly, butt, trapezoids, and other polygonal forms possessing sharp, flat, and/or rounded edges.

16. The separable mounting hinge device of claim 1 wherein each component is composed of metallic, metallic alloy, or polymeric materials that are strong, robust, durable, and corrosion resistant.

17. The separable mounting hinge device of claim 16 wherein each component is composed of steel, aluminum, brass, bronze, iron, copper, zinc, nickel, or similarly characterized polymer materials.

18. The separable mounting hinge device of claim 1 further comprising:
A retention member affixed about the at least one open knuckle of the second hinge member.

19. The separable mounting hinge device of claim 16 wherein the retention member is a ring or clip intended to further retain the length of pin of the at least one open knuckle seat within the at least one open knuckle of the second hinge member.
